(19) United States
(12) Patent Application Publication
(10) Pub. No.: US 2011/0109206 A1
(43) Pub. Date: May 12, 2011

(54) BICYCLE POWER GENERATOR

(76) Inventor: Johnson LI, Taichung Hsien (TW)

(21) Appl. No.: 12/615,245

(22) Filed: Nov. 9, 2009

(51) Int. Cl. H02K 7/00

(52) U.S. Cl. 310/67 R

(57) ABSTRACT

A bicycle power generator includes a tube which is adapted to be installed in a bottom bracket of a bicycle. The tube has a receiving space defined therein. A plurality of coil stators is annularly disposed in an inner periphery of the receiving space. A rotary shaft axially passes through the tube. The rotary shaft has a plurality of magnets annularly disposed on an outer periphery thereof. The plurality of magnets are intervally alternately arranged in north and south polarities. Each end of the rotary shaft has a threaded portion formed thereon for adapting to threadedly connect with a bicycle crank, such that the rotary shaft rotates with the bicycle crank. When the rotary shaft synchronously rotates with the bicycle crank, the plurality of magnets disposed on the rotary shaft is axially rotated relative to the coil stators such that the coil stators generate electricity.

### BACKGROUND OF THE INVENTION

1. Field of the Invention

The present invention relates to a bicycle power generator, and more particularly to a bicycle power generator installed in a bottom bracket of a bicycle.

2. Description of Related Art

A bicycle is usually equipped with a power generator so as to supply electricity to a lighting device mounted on the bicycle to enhance the safety when riding. A conventional bicycle power generator in accordance with the prior art comprises a stator mainly consisting of coils, and a rotor mainly consisting of a magnet, both of which are combined together by means of a bearing. More particularly, the stator is fixed on a fork of a bicycle, whilst the rotor is fixed onto spoke members of a bicycle wheel. While the bicycle is running, the rotation of a bicycle wheel will cause the rotor to rotate, thereby enabling the generator to produce electricity.

Despite the power generating function it provides, the conventional bicycle power generator bears several disadvantages. Since the rotor is fixed onto spoke members of a bicycle wheel, there is only a low strength in the fixation of the rotor, resulting in a problem that the rotor is apt to fall off the spoke members when the bicycle wheel rotates. Moreover, the stator and the rotor of the conventional bicycle power generator are exposedly disposed on the fork and the spoke members of the bicycle. Therefore, the stator and the rotor are easily impaired by exposing to the sun and rain, or by accidental collisions with solid materials, which consequently lead to malfunction to the rotor and the stator. Moreover, the stator is fixed on the fork of a bicycle, a number of the coils that could be disposed is limited due to a fairly limited space of the fork, consequently, a power that the conventional bicycle power generator could provide is small, and may not be able to suffice the power required.

The present invention has arisen to obviate/mitigate the disadvantages of the conventional bicycle power generator.

### SUMMARY OF THE INVENTION

The main objective of the present invention is to provide an improved bicycle power generator.

To achieve the objective, a bicycle power generator in accordance with the present invention comprises a tube which is adapted to be installed in a bottom bracket of a bicycle, and a rotary shaft which axially passes through the tube. The tube has a receiving space defined therein. A plurality of coil stators is annularly disposed in an inner periphery of the receiving space. The rotary shaft has a plurality of magnets annularly disposed on an outer periphery thereof. The plurality of magnets is intervally alternately arranged in north and south polarities. Each end of the rotary shaft has a threaded portion formed thereon. Two caps are respectively connected to two ends of the tube. Each cap has a penetrating hole defined therein. The threaded portions of the rotary shaft respectively pass through the penetrating holes and are threadedly connected with bicycle cranks, such that the rotary shaft rotates with the bicycle cranks. Each cap has a connecting portion formed on one end thereof for adapting to connect with the bottom bracket. Each connecting portion has a plurality of threads annularly formed on an outer periphery thereof, such that the connecting portions are provided to threadedly connect with the bottom bracket of the bicycle. Therefore, the caps are partially received in the bottom bracket and the tube is securely installed therein. Each cap has a bearing which is disposed in an inner periphery thereof for holding the rotary shaft. The rotary shaft axially passes through the tube via the bearings, such that the magnets disposed on the rotary shaft are inserted into the tube. An electricity storage device is electrically connected to the coil stators.

When the rotary shaft is rotated, the bearings stably hold the rotary shaft, and the rotary shaft is axially disposed in the receiving space. The rotary shaft is interspaced relative to the coil stators, such that the plurality of magnets does not collide with the coil stators during rotation.

When the rotary shaft synchronously rotates with the bicycle cranks, the plurality of magnets disposed on the rotary shaft axially rotates relative to the coil stators such that the coil stators generate electricity.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of the bicycle power generator in accordance with the present invention;

FIG. 2 is an assembled perspective view of the bicycle power generator in accordance with the present invention, showing the bicycle power generator assembled with a bottom bracket of a bicycle;

FIG. 3 is a cross-sectional view of the bicycle power generator in accordance with the present invention;

FIG. 4 is a cross-sectional view of the tube of segment A-A in FIG. 3 in accordance with the present invention, showing the rotary shaft interspacedly disposed relative to the coil stators; and

FIG. 5 is an assembled perspective view of the bicycle power generator in accordance with the present invention, showing an electricity storage device electrically connected with the coil stators.

### DETAILED DESCRIPTION OF THE INVENTION

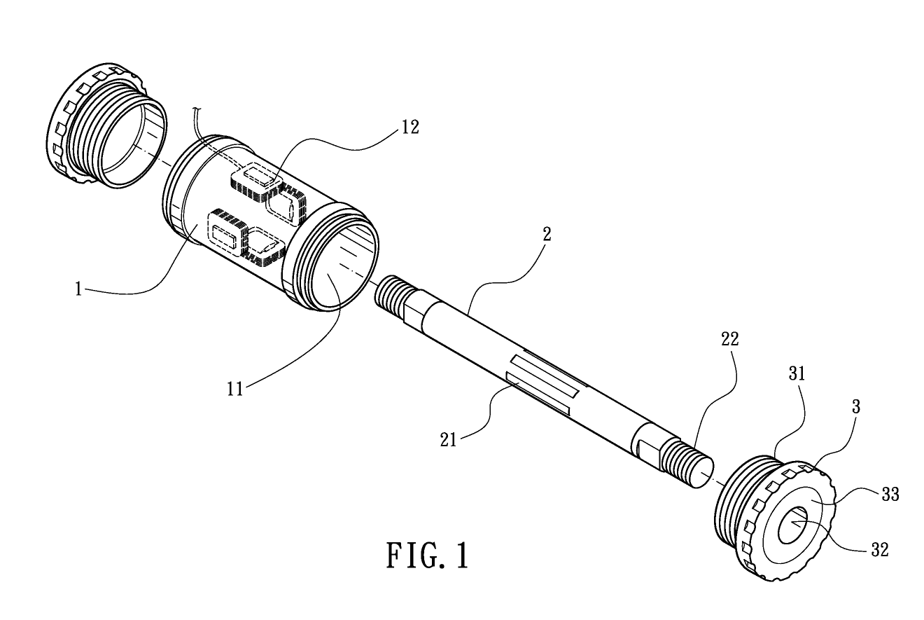

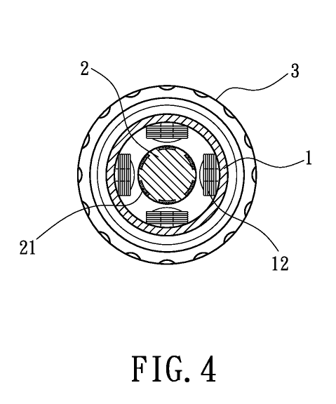

Referring to the drawings and initially to FIGS. 1-4, a bicycle power generator in accordance with the present invention comprises a tube 1 which is adapted to be installed in a bottom bracket (not numbered) of a bicycle (not shown), and a rotary shaft 2 which axially passes through the tube 1. An outer diameter of the tube 1 is smaller than an inner diameter of the bottom bracket, such that the tube 1 fits into the bottom bracket. The tube 1 has a receiving space 11 defined therein. A plurality of coil stators 12 is annularly disposed in an inner periphery of the receiving space 11. The rotary shaft 2 has a plurality of magnets 21 annularly disposed on an outer periphery thereof The plurality of magnets 21 are intervally alternately arranged in north and south polarities. Each end of the rotary shaft 2 has a threaded portion 22 formed thereon. Two caps 3 are respectively connected to two ends of the tube 1. Each cap 3 has a penetrating hole 32 defined therein, a connecting portion 31 which is formed on one end of the cap 3 for adapting to connect with the bottom bracket, and a bearing 13 which is disposed in an inner periphery of the cap 3 for holding the rotary shaft 2.

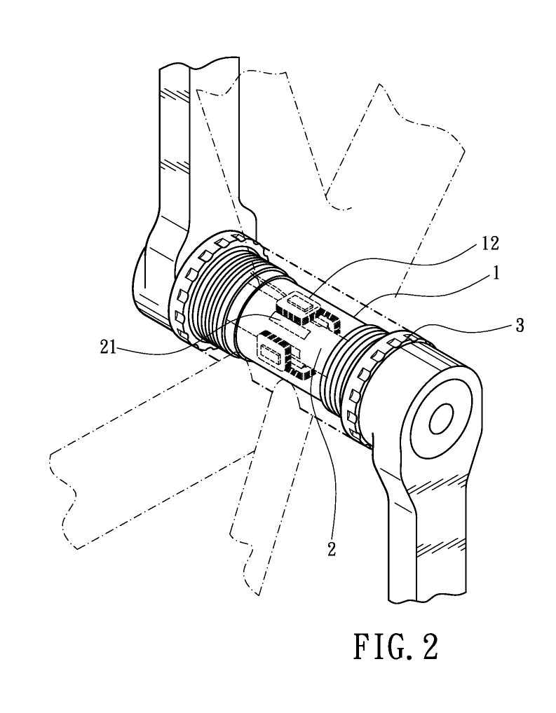

As shown in FIG. 2, the two threaded portions 22 of the rotary shaft 2 respectively pass through the two penetrating holes 32. The two threaded portions 22 protrude from the two penetrating holes 32 and are respectively threadedly connected with two cranks (not numbered) of the bicycle, such that the rotary shaft 2 synchronously axially rotates with the bicycle cranks. Each connecting portion 31 has a plurality of threads annularly formed on an outer periphery thereof for threadedly connecting with the bottom bracket of the bicycle, thereby the caps 3 are partially received in the bottom bracket. The rotary shaft 2 axially passes through the tube 1 via the bearings 33, such that the plurality of magnets 21 disposed on the rotary shaft 2 are inserted into the tube 1, and the tube 1 is securely installed in the bottom bracket to prevent the coil stators 12 and the plurality of magnets 21 from externally exposed; such that the coil stators 12 and the plurality of magnets 21 are not stained by dust, and are operated without outside interference. Therefore, usage lives of the coil stators 12 and the plurality of magnets 21 are effectively increased.

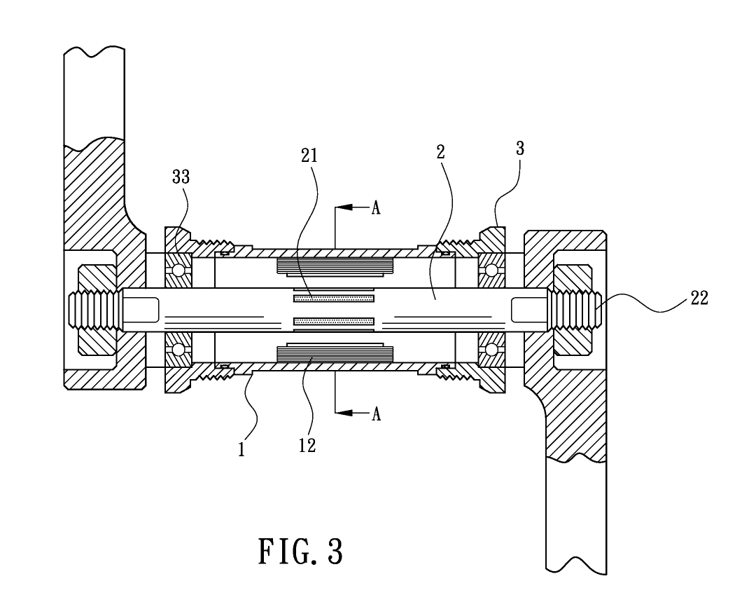

When the rotary shaft 2 is rotated, the bearings 33 stably hold the rotary shaft 2. As shown in FIG. 3, the rotary shaft 2 is axially disposed in the receiving space 11, and the rotary shaft 2 is interspaced relative to the coil stators 12, such that the plurality of magnets 21 does not collide with the coil stators 12 during rotation, and prevent the coil stators 12 from malfunction due to collision.

When the rotary shaft 2 synchronously rotates with the bicycle cranks, the plurality of magnets 21 disposed on the rotary shaft 2 axially rotates relative to the coil stators 12, such that an electromagnetic effect is produced for the coil stators 12 to generate electricity. In the present embodiment, four coil stators 12 are disposed in the receiving space 11, additional coil stators are to be disposed for generating greater power.

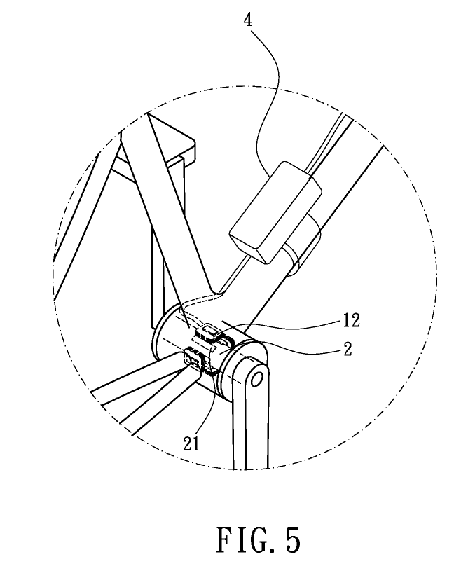

Referring to FIG. 5, an electricity storage device 4 is electrically connected to the coil stators 12 for storing the electricity generated from the electromagnetic effect produced by the coil stators 12. The electricity storage device 4 is mounted to a down tube (not numbered) of the bicycle.

Although the invention has been explained in relations to its preferred embodiment, it is to be understood that many other possible modifications and variations can be made without departing from the spirit and scope of the invention as hereinafter claimed.

What is claimed is:

1. A bicycle power generator comprising:
a tube adapted to be installed in a bottom bracket of a bicycle, the tube having a receiving space defined therein; a plurality of coil stators annularly disposed in an inner periphery of the receiving space; and
a rotary shaft axially passing through the tube, the rotary shaft having a plurality of magnets annularly disposed on an outer periphery thereof, the plurality of magnets intervally alternately arranged in north and south polarities; each end of the rotary shaft having a threaded portion formed thereon for adapting to threadedly connect with a bicycle crank, such that the rotary shaft rotates with the bicycle crank;
wherein when the rotary shaft synchronously rotates with the bicycle crank, the plurality of magnets disposed on the rotary shaft is axially rotated relative to the coil stators such that the coil stators generate electricity.

2. The bicycle power generator as claimed in claim 1, further comprising two caps respectively connected to two ends of the tube; each cap having a penetrating hole defined therein, the threaded portions of the rotary shaft respectively passing through the penetrating holes; each cap having a connecting portion formed on one end thereof for adapting to connect with the bottom bracket; wherein the caps are partially received in the bottom bracket and the tube is securely installed therein.

3. The bicycle power generator as claimed in claim 2, wherein each cap includes a bearing disposed in an inner periphery thereof for holding the rotary shaft; the rotary shaft axially passing through the tube via the bearings, such that the plurality of magnets disposed on the rotary shaft are inserted into the tube;
wherein when the rotary shaft is rotated, the bearings stably hold the rotary shaft, the rotary shaft axially disposed in the receiving space, the rotary shaft being interspaced relative to the coil stators, such that the plurality of magnets do not collide with the coil stators during rotation.

4. The bicycle power generator as claimed in claim 2, wherein each connecting portion has a plurality of threads annularly formed on an outer periphery thereof, such that the connecting portions are provided for threadedly connecting with the bottom bracket of the bicycle.

5. The bicycle power generator as claimed in claim 1, further comprising an electricity storage device electrically connected to the coil stators.
